(19) United States
(12) Patent Application Publication
(10) Pub. No.: US 2005/0128051 A1
(43) Pub. Date: Jun. 16, 2005

(54) Verification key for replacement parts

(76) Inventors: Robert Dickinson, London (GB); David Arnold, Surrey (GB)

Correspondence Address: Fulwider Patton;Lee & Utecht, Howard Hughes Center, 6060 Center Drive Tenth Floor, Los Angeles, CA, 90045, US

(21) Appl. No.: 10/500,417

(22) PCT Filed: Dec. 19, 2002
(86) PCT No.: PCT/GB02/05800

(30) Foreign Application Priority Data
Dec. 27, 2001 (GB) 0130978.0
Oct. 1, 2002 (GB) 0222744.5

(51) Int. Cl. H04Q 1/00

(52) U.S. Cl. 340/5.61

(57) ABSTRACT

The present application relates to methods and apparatus for verifying the authenticity of, or ensuring the correct substitution of, replacement units which connect to a master device in order to facilitate the operation of that device. A verification means to determine the authenticity and/or the correct connection of the replacement unit is provided in the form of a remotely detectable tag, such as an optical or magnetic tag, which is provided in or on the replaceable unit. A detection system is then provided in the master unit which provides a means to excite the tag when the replaceable unit when brought into proximity with the master unit, and which also provides a means to detect the response of the tag to the excitation means.

The present invention relates to methods and apparatus for verifying the authenticity of, or ensuring the correct substitution of, replacement units which connect to a master device in order to facilitate the operation of that device.

Devices and systems which comprise a master unit and a replaceable unit, such as a printer and print cartridge, an electric toothbrush and head, or a vending machine and container, often suffer from the disadvantage that the replaceable unit can be replaced by inferior copies or substitutes. This can result in a reduction in the performance of the device or can reduce the quality of the delivered item. In some cases the user is not aware of the substitution, and will attribute the reduced quality to the provider of the original machine thus damaging the reputation of the supplier.

A similar problem can arise in a number of medical applications where the substitution of a poor quality replacement unit, or the incorrect substitution of a replacement unit, or the incorrect re-use of a replacement unit can have serious safety implications. For example, the administration of medication by means of a dispensing pump requires the correct connection of a medical infusion tube to the dispenser.

A number of techniques have been previously considered in order to prevent incorrect or inferior quality substitution of replacement parts. Mechanical interlocks have been employed which consist of two parts, one part being incorporated into the master unit and the other in the replacement unit so that the two parts must complement each other to allow the units to be coupled together. Mechanical interlocks however, have the disadvantage that they are relatively easy to copy and so copy substitutes can be easily manufactured. Furthermore, the number of valid replacement parts will be quite limited and complicated mechanical interlocks can impair the convenient substitution of a replacement unit such as, for example, the removal of a spent printer cartridge and the replacement of a new cartridge.

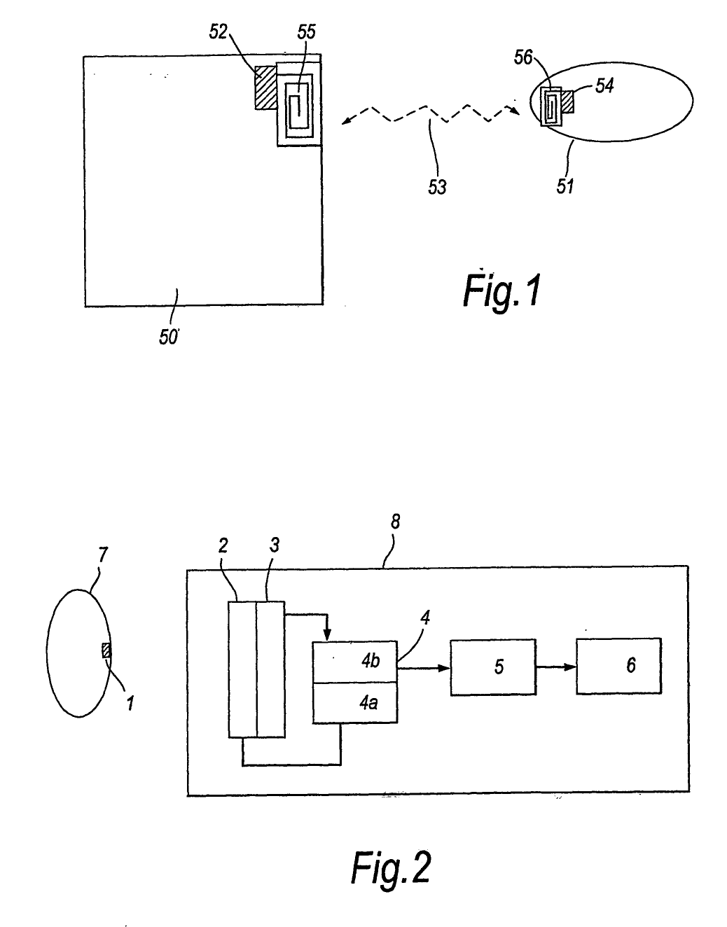

Many products require the use of electronic controls to operate the device. In such cases it becomes possible to incorporate an electronic “key” into the replacement unit that will be detected by a detection apparatus coupled to the master unit. One such electronic key is illustrated in FIG. 1 and consists of a programmable integrated circuit, programmed with a suitable code. This key can be read via a suitable electrical connector, or via a short range radio frequency transmitter/receiver arrangement. Such circuits can often provide a successful means of verifying the authenticity, or ensuring the correct substitution, of replacement parts. However, due to ready access to standard circuit production techniques, they are also moderately easy to copy. Furthermore, the cost of such devices can be significant and would be inappropriate for low cost replacement units such as disposable cups for a drinks vending machine.

Preferred embodiments of the present invention seek to alleviate the problems associated with previously known techniques by providing a low-cost electronic key that is difficult to reproduce and which can carry a number of codes that can be machine readable.

In cases where incorrect substitution of a replacement part may still take place, or where a valid replacement unit may be incorrectly installed or become moved relative to the master unit, it is also desirable for embodiments of the present invention to be able to alert a user to the incorrect substitution, by causing the operation of the master unit to be modified. In cases where incorrect re-use of a replacement part may occur, it is further desirable to be able to modify the key in order to detect use.

The modification of operation may include reverting to a default mode which has a sub-optimum (but preferably predetermined) performance. As the quality of the replacement unit cannot be guaranteed, an inferior quality or poor quality unit may be installed which may not be capable of producing the same performance as the authentic replacement unit.

According to one aspect of the present invention there is provided an apparatus comprising a master unit and one or more replacement units which connect to the master unit so as to facilitate the operation of said apparatus, the apparatus being provided with a verification means to determine the authenticity and/or the correct connection of the replacement unit, wherein if the replacement unit is not found to be authentic, or is incorrectly connected to the master unit, the operation of the apparatus is modified.

The verification means preferably comprises a remotely detectable tag, such as an optical or magnetic tag, which is provided in or on the replaceable unit. A detection system is then provided in the master unit which will excite the tag when the replaceable unit is brought into proximity with the master unit, and which also provides a means to detect the response of the tag to the excitation means.

Preferred embodiments of the invention employ the use of a magnetic tag having one or more pieces of magnetic material, the tag being incorporated in, or provided on, the replaceable unit. A number of tag embodiments are known such as those described in WO 97/04338 and WO 96/31790, the disclosures of which are incorporated herein by way of reference thereto.

The master unit is then preferably provided with a detection system comprising a means to generate a magnetic interrogation field, to which the magnetic tag will be subjected when the replacement unit is coupled to the master unit, and a means to detect the resultant magnetic response of the magnetic tag. The magnetic tag and the detection system thereby comprise the verification means. Furthermore, the master unit is advantageously provided with a signal processing means which can control the operation of the apparatus in accordance with the magnetic response of the tag.

Preferably, the magnetic material comprises low coercivity, high permeability (˜10000) magnetic material which is advantageously in the form of a thin film of less than 1 micron thick and which preferably has a typical coercivity of less than 10 Amps/m. The magnetic permeability of the material exhibits a preferred axis of magnetisation so that when the material is excited with an ac magnetic field parallel to the preferred axis of permeability, the material will be easily saturated. The magnetic field of the saturated material will advantageously comprise a non-linear function of the interrogation field, and will consist of harmonics of the exciting field which may be remotely detected. The presence of these harmonics will indicate the presence of this material, and so the material can be introduced into a consumable as an electronic key. The detection of such material is non-contact, as no electrical connection is required between the tag and the detection system.

In a further embodiment of the present invention the tag is constructed so that at least one of the features may be interrogated at a greater range than the other features of the tag. This may preferably be achieved by providing a tag with a plurality of elements wherein at least one of the elements is of greater length or width than the other elements. This embodiment of the present invention has the advantage that the tag will exhibit two levels of encoded information. The first level may be relatively limited in content, but may be read at a greater distance or through the outer packaging of the replaceable unit. The second level, containing more detailed information, can be read only when the replaceable unit is removed from the packaging or the unit is brought within a specified distance from the master unit housing the interrogation means.

In a further embodiment of the present invention the tag comprises low coercivity magnetic material positioned in close proximity to high or medium coercivity material which is capable of being permanently magnetised. Preferably both the low coercivity and medium or high coercivity magnetic materials comprise continuous layers which are superimposed on one another. A tag of this kind is described in detail in WO98/13708, the disclosure of which is incorporated herein by way of reference thereto.

The magnetisation of the high or medium coercivity material can be set in manufacture to bias the soft, low coercivity magnetic material. Discrete regions of the high or medium coercivity material may then be magnetised so as to form a pattern of magnetised and un-magnetised regions. In regions where the hard magnetic material is magnetised, the overlaying soft (low-coercivity) magnetic material is saturated and therefore becomes magnetically inactive. These inactive regions will act as gaps whereas regions of soft magnetic material, which are not saturated by the hard, bias material, will constitute elements. In this way, the soft magnetic material may be encoded to provide information about, for example, the replacement or master unit.

The process of writing the magnetic pattern on the high coercivity magnetic material can be achieved by using a magnetic recording head which is in contact, with the material. In this way, it is possible for the information contained by the elements of soft magnetic material to be modified.

Although the magnetic bias pattern must be written with a contact writer, it can advantageously be erased by a non-contact demagnetisation coil mounted in the master unit. This could be used to erase or modify the magnetisation pattern of the tag once the replaceable unit is mounted in the master unit. IN this way, the prior use of a replaceable unit can be identified. Furthermore, by laminating a protective film over the tag, contact re-writing will be prevented, so that restoration of the original magnetic pattern, and thus the re-use of the removable component, can be prevented. The protective film can be polypropylene, paper or other commonly used label materials, with a thickness of preferably more than 100 microns.

Numerous materials are commercially available which can be satisfactorily used in this invention. For example, one suitable material that could be used for the low-coercivity material is the thin-film material supplied by IST of Belgium under the name Atalante. This material has a typical intrinsic coercivity of 105 and a low frequency coercivity of a few A/m.

Suitable coding materials, i.e. materials used for the bias material, are finely divided ferromagnetic oxides with coercivities in the range 100 to 6000 oersted. Suitable materials are available commercially from many suppliers such as BASF (Germany) and TDK (Japan), and are generally used for the manufacture of magnetic recording media.

For a better understanding of the present invention, and to show how the same may be carried into effect, reference will now be made, by way of example, to the accompanying drawings, in which:

FIG. 1 shows an apparatus having a master unit and a replacement unit and incorporating a verification means according to the prior art;

FIG. 2 shows an apparatus having a master unit and a replacement unit and incorporating a verification means according to an embodiment of the present invention;

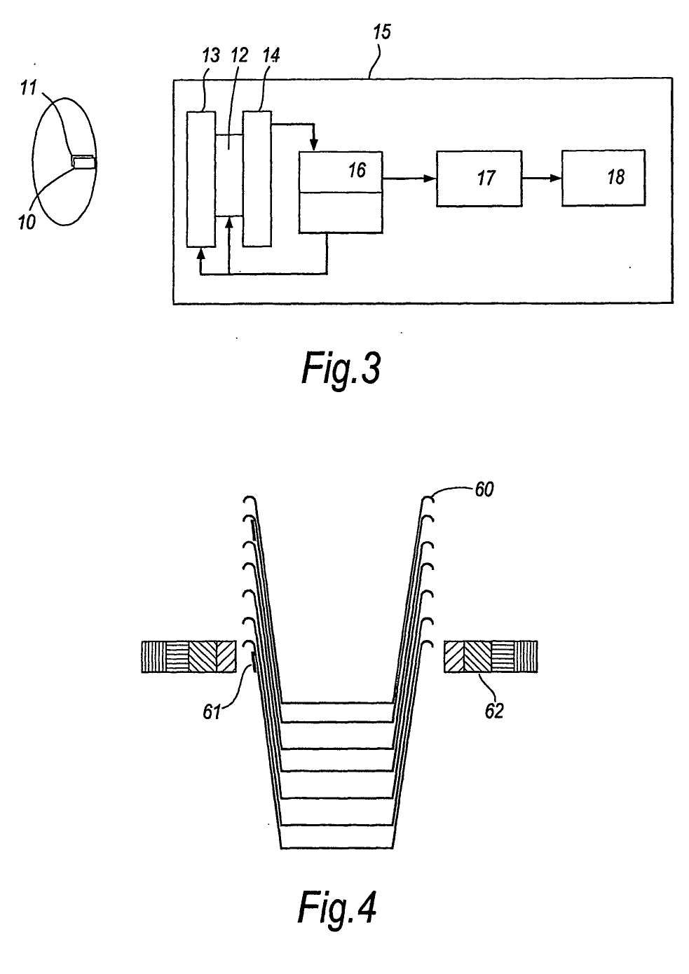

FIG. 3 shows a further embodiment of the present invention; and

FIG. 4. illustrates an embodiment of the present invention in which the master unit comprises a drinks vending machine and the replaceable unit is a disposable cup.

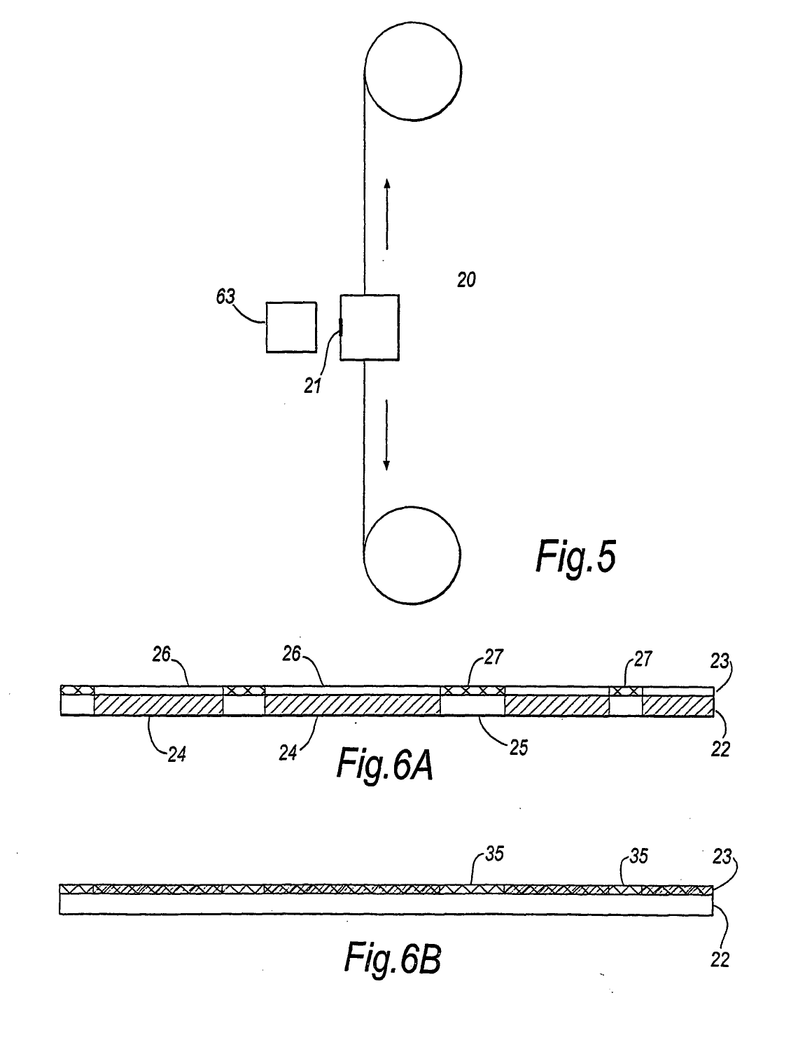

FIG. 5 shows an embodiment of the present invention in which the master unit is a printer and the replacement unit is a printer cartridge.

FIGS. 6A and 6B illustrates a tag embodying the present invention in which the encoded information can be erased to prevent re-use; and

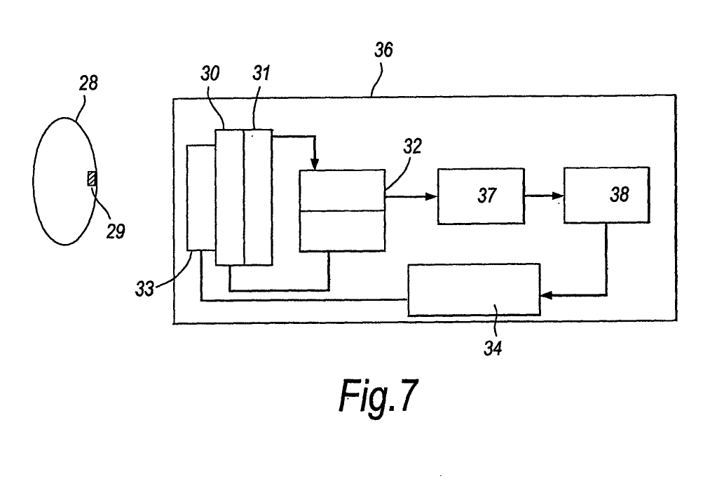

FIG. 7 illustrates an apparatus having a master unit and a replacement unit and incorporating a verification means and an erasing means according to a further embodiment of the present invention.

The prior art system shown in FIG. 1 comprises a base (or master) unit (50), having an RFID reader (52) and antenna (55) arrangement which receives radio frequency communication (53) transmitted by an RFID tag (54) and antenna arrangement (56) provided on a replaceable unit (51).

The verification system shown in FIG. 2 comprises a replaceable consumable (7), having a magnetic tag (1) attached thereto. When the consumable (7) is correctly replaced in the master unit, it will be subjected to an interrogation system provided in the master unit (8). The interrogation system provided in the master unit (8) comprises a transmit coil (2) to generate a magnetic field in the region where the tag will be, a receive coil (3) to receive the magnetic response of the tag to the transmit field, and front-end electronics (4) to generate and transmit (4a) the exciting field and amplify and process the signal received (4b) from the received coil. The received signal is then passed to a signal detector (5), which identifies the presence of the signal, and produces a logic signal which is passed to the master unit controller (6). The master unit controller is arranged to modify or suspend the operation of the master unit if there is no electronic key detected, or if an incorrect or distorted signal is obtained. In this way, a user will be alerted to the substitution of an inferior quality replacement unit or an incorrect substitution of an authentic replacement unit. The modification of operation may include reverting to a default mode which has a sub-optimum performance, as the quality of the replacement unit cannot be guaranteed so it may not be capable of producing the same performance as the authentic replacement unit.

In a number of further embodiments the tag can be encoded by having several pieces (or elements) of the magnetic element. The elements can be arranged on a substrate such that the spacing between them is employed to encode information between the tag. The magnetic properties of the elements may also be used as a further means to encode information so that some or all of the elements has a unique attribute.

FIG. 3 shows an embodiment of the present invention in which a magnetic tag is provided on the replaceable consumable unit. This tag configuration (described in more detail in WO 97/04338) comprises a first layer (10) of magnetic material characterised by high permeability, low coercivity and a non-linear B-H characteristic. The low coercivity layer (10) is coated with a second layer (11) of magnetic material which is capable of being permanently magnetised so that it acts as a magnetic bias region. When the tag is interrogated by an interrogation field generated by the transmit coil (13) and field bias coil (13), the low coercivity layer will only be driven out of saturation when the magnetic bias level of the neighbouring layer (11) is overcome. In more complex tag configurations, the said second layer of magnetic material can comprise three or more discrete regions of magnetic bias material and each of the discrete regions can exhibit a different combination of magnetisation level and direction such that, during interrogation by a constant frequency alternating magnetic field, the magnetic bias levels of each of said discrete regions are overcome at different times in the interrogation cycle so that the value of magnetic bias field required to overcome the high coercivity layer can uniquely identify the element(s).

The interrogation field in this embodiment comprises a high amplitude, low frequency scanning field, which is generated by the field bias coil (12), and is capable of overcoming the bias of the high coercivity layer (11). In addition, a low amplitude, high frequency field is generated to which the low coercivity layer (10) will respond when the neighbouring bias has been overcome by the scanning field. The high frequency field creates signals which are harmonics of the interrogation frequency and which are detected by the receive coil (14). This embodiment of a tag does not require a relative motion between the tad and the reader.

The master unit (15) is also provided with front-end electronics (16) to process the signal received by the receive coil (14). The received signal is then passed to a signal detector (17), which identifies the presence of the signal, and produces a logic signal which is passed to the master unit controller (18). The master unit controller is arranged to modify or suspend the operation of the master unit if there is no electronic key detected, or if an incorrect or distorted signal is obtained. In this way, a user will be alerted to the substitution of an inferior quality replacement unit or an incorrect substitution of an authentic replacement unit.

A magnetic tag can also be encoded so that it may be used to act as more than just a presence indicator. For example the brush in an electric toothbrush may have different variants which require different speed settings in the motor. So the magnetic tag may provide two functions, first it acts as an electronic key, which is difficult to copy, and second it carries codes which can be interrogated and then conveyed to the master unit controller to control the operation of the master unit.

FIG. 4 shows an embodiment of the present invention in which the master unit comprises a drinks vending machine and the replaceable unit (60) is a disposable cup. The verification system is arranged so that the operation of the vending machine will depend upon the identification of the correct magnetic tag (61). The master control unit is provided with a transmit and receive coil assembly (62) which can be arranged to suspend the operation of the vending machine altogether, or may instead be arranged to alert the user in some other way, e.g. by going slow or by preventing the dispensation of an unauthentic cup.

In another embodiment, the tag consists of a number of elements arranged with defined gaps between them. The pattern of elements can be used to form a code, similar to an optical barcode. Such a tag has been disclosed in a previous patent application WO96/31790, and the elements are interrogated by means of a magnetic field, known as a magnetic null field, which comprises a region of zero magnetic field which is contiguous with a region of high saturating magnetic field. The verification system will depend on measuring the response of a magnetic element to the different regions of the magnetic null field. When a given element is within the region of high magnetic field, it is completely saturated by an applied static magnetic field. However, when the elements enter the region of zero magnetic field, they are driven out of saturation and will respond to the change in magnetic field level by generating a harmonic of an applied ac magnetic field. By causing relative movement between the tag element(s) and the magnetic null field, signals will be produced at different time intervals which correspond to the arrangement of the magnetic elements on the tag.

This embodiment can be used to identify consumables in a situation where the consumable is moved relative to the master unit, such as a print cartridge (20) and printer, where the tag (21) both acts as an electronic key and carries a code which controls the master unit as shown in FIG. 5. For example, the tag can be encoded and used to ensure that the correct colour cartridge is put in the correct slot in the printer. It can also be used to alter the print parameters, so that inferior cartridges without a tag will consequently be detected by the fixed read head (63) and the printer will then be limited in its function to slower or lower resolution operating modes.

A tag as shown in FIGS. 6A and 6B is created by bonding a layer of high-coercivity material (22), which is capable of being permanently magnetised, to a layer of soft magnetic material (23). A plurality of regions (24) of the high-coercivity material are magnetised using a contact recording head, such as is as used in magnetic recording machines, to form a magnetic pattern comprising discrete magnetised (24) and un-magnetised (25) regions. In regions where the hard magnetic material (22) is magnetised, the overlaying soft (low-coercivity) magnetic material is saturated and therefore becomes magnetically inactive. These inactive regions (26) will act as gaps whereas regions (27) of soft magnetic material which are not saturated by the hard, bias material, will constitute elements. In this way, the soft magnetic material may be encoded to provide information about, for example, the replacement or master unit.

The tag may be modified by demagnetising the high coercivity material, so that more regions (35) of the soft magnetic material become unsaturated as shown in FIG. 6B. These regions are then capable of producing harmonic signals when interrogated by a reader of the sort depicted in FIG. 2.

The process of demagnetising the high coercivity magnetic material can be achieved by generating a suitable current pulse, such as an exponentially decaying sine wave, through a remote coil. This process does not require a contact recording head to demagnetise relatively large regions such as the whole tag. It thus becomes possible to detect if a tag has been demagnetised (and therefore if the replaceable article to which it is attached has been put to use) from the altered properties of the response signal generated by soft, low coercivity magnetic material. The tag of FIG. 6 is also provided with a protective laminate which prevents contact re-writing of the magnetic pattern

FIG. 7 illustrates an apparatus having a master unit and a replacement unit and incorporating a verification means according to an embodiment of the present invention and a means for modifying the verification means.

The verification system shown in FIG. 7 comprises a replaceable consumable (28), having attached thereto a magnetic tag (36), comprising a first magnetic material having a low magnetic coercivity and a second magnetic material having a medium or high magnetic coercivity and being capable of being permanently magnetised. When the consumable is correctly replaced in the master unit (36), it will be subjected to an interrogation system provided in the master unit. The interrogation system provided in the master unit (29) comprises a transmit coil (30) to generate a magnetic field in the region where the tag will be, a receive coil (31) to receive the magnetic response of the tag to the transmit field, and front-end electronics (32) to generate the exciting field and amplify and process the signal from the received coil. The received signal is passed to a signal detector (37), which identifies the presence of the signal, and produces a logic signal which is passed to the master unit controller (38). The master unit controller is arranged to modify or suspend the operation of the master unit if there is no electronic key detected, or if an incorrect or distorted signal is obtained. In this embodiment, the master unit (36) incorporates a demagnetising coil (33) and demagnetising driver (34), which is coupled to the master unit controller (38), that can demagnetise any prior magnetisation in the high coercivity material present on the tag. During the process of demagnetisation, contact with the tag is not required. The verification means can detect the modification of the tag and control the unit accordingly so that the attempted re-use of the replacement unit can be detected and prevented. Furthermore, due to the present of the protective laminate, it becomes possible to prevent the unauthorised re-magnetisation, or re-writing, of the original magnetic pattern, since the contact necessary for the recording process is prevented.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. An apparatus comprising a master unit and one or more replacement units which connect to the master unit so as to facilitate operation of said apparatus, the apparatus being provided with a verification means to determine the authenticity and/or the correct connection of the replacement unit, wherein if the replacement unit is not found to be authentic, or is incorrectly connected to the master unit, the operation of the apparatus is modified, characterized in that the verification means comprises:
i) a remotely detectable tag provided on, or incorporated in, the replacement unit; and
ii) an interrogation means provided in the master unit for interrogating the replacement unit to determine the authenticity of that unit and/or determine if the replacement unit is correctly connected to the master unit, as indicated by the response of the remotely detectable tag.

22. An apparatus as claimed in claim 21, wherein the interrogation means comprises:
i) a magnetic field generating means for generating a magnetic field in the region where the replacement unit will be connected; and
ii) a means for detecting the response of the tag to said magnetic field.

23. An apparatus as claimed in claim 21, wherein the remotely detectable tag comprises one or more pieces of magnetic material.

24. An apparatus as claimed in claim 23, wherein the magnetic material comprises low coercivity, high permeability magnetic material.

25. An apparatus as claimed in claim 21, wherein the tag comprises a plurality of discrete elements and wherein the elements represent two levels of encoded information so that the content of one of the levels of encoded information is capable of being read by interrogation through the packaging of the replacement unit and/or interrogation at a greater distance from the interrogation means than the content of the other level of encoded information.

26. An apparatus as claimed in claim 21, wherein the tag comprises a plurality of discrete elements which are arranged such that the relative positions of the elements represents information.

27. An apparatus as claimed in claim 26, wherein the information represented by the plurality of elements identifies the type of replaceable unit and wherein the operation of the master unit is modified in accordance with the type of replaceable unit which is or has been connected.

28. An apparatus as claimed in claim 21, wherein the tag comprises:
i) a first magnetic material having a low magnetic coercivity; and
ii) a second magnetic material having a medium or high magnetic coercivity and being capable of being permanently magnetized.

29. An apparatus as claimed in claim 28, wherein selected regions of the second magnetic material are permanently magnetized to form a magnetic pattern.

30. An apparatus as claimed in claim 29, wherein a recording head in contact with the second magnetic material is required in order to form the magnetic pattern thereon.

31. An apparatus as claimed in claim 28, wherein the interrogation means further comprises a demagnetizing coil which serves, in use, to erase or modify the magnetic pattern.

32. An apparatus as claimed in claim 28, wherein the tag further comprises a protective layer.

33. An apparatus as claimed in claim 21, wherein the master unit comprises an electric toothbrush handle and the replaceable unit comprises a brush.

34. An apparatus as claimed in claim 21, wherein the master unit comprises a printer and the replaceable unit comprises a printer cartridge.

35. An apparatus as claimed in claim 27, wherein the modification of the operation of the apparatus does not comprise preventing the operation of the apparatus.

36. An apparatus as claimed in claim 27, wherein the modification of the operation of the apparatus comprises a predetermined, sub-optimum default operating mode.

37. An apparatus as claimed in claim 21, wherein the operation of the apparatus comprising the master unit and the replacement unit serves a medical application.

38. An apparatus as claimed in claim 37, wherein the master unit comprises a medicine dispensing pump and the replacement unit comprises a medical infusion tube.

39. An apparatus as claimed in claim 37, wherein the modification of the operation of the apparatus comprises suspending the operation of the apparatus.
